(19) United States
(12) Patent Application Publication
(10) Pub. No.: US 2022/0180676 A1
(43) Pub. Date: Jun. 9, 2022

(54) SYSTEM FOR ANALYZING DATA IN A VEHICLE

(71) Applicant: Volvo Truck Corporation, Göteborg (SE)

(72) Inventor: Oscar Thaung, Göteborg (SE)

(21) Appl. No.: 17/599,066

(22) PCT Filed: Dec. 18, 2019
(86) PCT No.: PCT/EP2019/085890

§ 371 Date: Sep. 28, 2021

(30) Foreign Application Priority Data
Apr. 8, 2019 (SE) 1950433-1

(51) Int. Cl. G07C 5/08; G07C 5/00; G07C 5/12; H04L 12/40

(52) U.S. Cl. CPC G07C 5/0825; G07C 5/008; H04L 2012/40215; H04L 12/40; H04L 2012/40273; G07C 5/12

(57) ABSTRACT

The present disclosure relates to a system (200) for analyzing data in a vehicle (100, 102, 04). The present disclosure also relates to a corresponding computer implemented method and to a computer program product.

### TECHNICAL FIELD

The present disclosure relates to a system for analyzing data in a vehicle. The present disclosure also relates to a corresponding computer implemented method and to a computer program product.

### BACKGROUND

Recent technical developments of vehicles, such as trucks, has resulted in the inclusion of an increasing number of electrical components, such as electronic control units (ECUs), sensors (e.g. connected to the ECUs), etc. Because of such development the analysis of faults within the vehicle has been made more complicated, resulting in a need to develop existing and new methods for diagnostics, fault detection and fault localization. In cases where a vehicle exhibits an erroneous function, such as due to a faulty vehicle component, it is of utmost importance to rapidly determine which component that is defect, to thereby be able to repair or exchange said defect component. Methods for locating a defect component can be applied both upon a determined symptom that indicates some form of defect functionality of the vehicle or in preventive purpose, wherein diagnostics is performed to minimize the risk of in a later stage being affected by operation disturbance or in worst case operation shut down.

Since the general trend for vehicles is that they become more complex, fewer technicians have a complete understanding of the overall vehicle system. Thus, it becomes more and more complex to perform fault search of vehicles, also resulting in that the cost for educating technicians and developing diagnostics tools increases. In terms of many different vehicle fleets, such as truck fleets, it is of utmost importance to have a high availability for the vehicles included therein to be available to be able to contribute to an efficient and lucrative business.

There is today several tools and methods for fault search and fault localization. One example of such an implementation is US2009157248, disclosing a method of displaying a vehicle's information, includes measuring a set values of the vehicle, comparing the set of measured values with a set of related normal values of a vehicle of the same type as the vehicle being measured, and operating within a preset normal range, and displaying on a video image a graphical depiction of the measured set of values in comparison to the normal set of values of the same type of vehicle.

Furthermore, US20130030641 presents a method for managing fault codes triggered by one or more vehicles during operation. For example, fault codes triggered during a particular time period while a vehicle is in operation are recorded and analyzed. As a result of the analysis, it is possible set a state for each of the identified fault codes, the state indicating a level of action to address the identified fault code. The fault code may subsequently be displayed at a screen.

Even though the implementations presented in each of US2009157248 and US20130030641 simplifies fault identification in a vehicle, it does not take into account the knowledge of a skilled technician. Rather, the prior-art solutions moves all of the decision making to the technical system, simply serving the technician with a possible solution. Taking the above into account, it would be interesting to provide further improvements in relations automated vehicle diagnostics, while at the same time taking into account valuable knowledge of skilled technicians.

### SUMMARY

According to an aspect of the present disclosure, the above is at least partly alleviated by a system for analyzing data in a vehicle, the system comprising a display screen provided with a graphical user interface (GUI), and processing circuitry arranged in communication with the display screen, wherein the processing circuitry is adapted to receive a stream of data relating to an electronic control unit (ECU) or a sensor comprised with the vehicle, the stream of data comprising a plurality of data elements, arrange the plurality of data elements in a plurality of different predetermined categories, form a graphical representation of the data elements for each of the categories, wherein each data element is mapped to a predetermined color based on a value of the data element, receive a graphical representation of the vehicle, identify a location of at least one of the ECU, the sensor or communication means therebetween, and display the graphical representation of the vehicle and the graphical representation of the data elements within the GUI, the graphical representation of the data elements being overlaid at the location of the ECU, the sensor, or at the communication means therebetween.

In accordance to the present disclosure, rather than just presenting complex error codes for a user (or technician), or presenting an estimated solution to the user, the stream of data generated by e.g. a sensor connected to an ECU or the ECU itself is “color-coded” before being presented to the user, possibly in an essentially raw form. That is, the plurality of data elements comprised with the stream of data, such as transmitted over e.g. a CAN bus or similar present or future communication bus comprised with the vehicle, is mapped to individual color segments based on the value of that specific data element. A flow of color-coded segments is then included in the graphical representation that is displayed to the user.

The communication means between the ECU and the sensor may in one embodiment include a wired or wireless CAN bus or similar. Other possible wired and/or wireless implementation of the communication means are of course possible and within the scope of the present disclosure.

An advantage with the present disclosure is thus that a skilled technician in a quick manner may visually draw a conclusion from the graphical representation of the data elements, since a skilled technician in many situations may remember how a flow of data to/from a specific sensor, ECU or communication means therebetween should likely appear in case of the sensor/ECU/communication means is “working properly”, such as from previous experience in relation to the same type of vehicle, ECU, sensor, or other component as comprised with the vehicle. This could in some sense be compared to a prior situation where a skilled technician could hear, feel or smell a behavior of the vehicle to draw a conclusion.

This is in line with the present disclosure achieved by the processing circuitry being adapted to receive a graphical representation of the vehicle (e.g. being a “map” of where components of the vehicle are located, possibly being a three-dimensional map), and “mapping” the graphical representation of the data elements to the graphical representation of the vehicle. The technician will thus be able to draw a conclusion on where a possible problem may reside.

Preferably, the display screen forms part of an augmented reality arrangement, the augmented reality arrangement represented by at least one of smart eyeglasses, a smartphone, a tablet, etc. Accordingly, in case the user is e.g. wearing virtually eyeglasses, it may be possible to allow the user to see the vehicle “in the background” with the graphical representation “in the foreground”, possibly dependent of how the user moves his head in relation to the vehicle.

A similar implementation is in line with the present disclosure possible, where e.g. the user may hold a tablet that is equipped with a camera continuously capturing a video sequence of the vehicle, when the user holds the tablet facing the vehicle. The graphical representation comprising the color-coded data elements may then be visualized in relation to an estimated or known position of the ECU or sensor comprised with the vehicle. That is, the graphical representation comprising the color-coded data elements is in this case “combined” with the video sequence of the vehicle in an augmented reality manner, such that the color-coded data elements appear in an expected vicinity of where the ECU/sensor is located within the vehicle, as will be further elaborated below.

Distinct differences in what would be a normal behavior may thus be easily identified and an action may be taken. As an example, in case a sensor/ECU normally producing e.g. blue data is shown to display e.g. another color, such as red, may be taken as an indication that something is erroneous in relation to the sensor/ECU.

In an embodiment of the present disclosure, the data elements are time stamped and the processing circuitry is further adapted to order the data elements in each category based on the time stamp prior to forming the graphical representation. Accordingly, the user reviewing the graphical representation will be allowed to review not only the latest data/information/values from the ECU, the sensor or a sensor connected to the ECU. Rather, the data/information/values from the ECU or sensor will appear to include a historical aspect of the data/information/values, e.g. allowing the user to identify patterns in relation to the data/information/values, such as fluctuations, etc.

In accordance to the present disclosure, the plurality of data elements may for example be hexadecimal values. As an example, the plurality of data elements communicated using the CAN bus may be arranged in a hexadecimal manner (16 base), where the color coding as a consequence may be mapped to sixteen different colors. The colors are preferably selected to be distinct in their appearance, meaning that it is preferred to map the values to different colors that are easily separated by the user when reviewing the graphical representation.

In a preferred embodiment of the present disclosure, the system is provided as a component of the vehicle, typically further comprising the above-mentioned ECU and sensor. The vehicle may in turn be e.g. one of a bus, a truck, a car, or any form of construction equipment. The vehicle may furthermore be at least one of a pure electrical vehicle (PEV) and a hybrid electric vehicle (HEV).

According to another aspect of the present disclosure there is provided a computer implemented method for operating a system adapted to analyze data in a vehicle, the system comprising a display screen provided with a graphical user interface (GUI), and processing circuitry arranged in communication with the display screen, wherein the method comprises the steps of receiving a stream of data relating to an electronic control unit (ECU) or a sensor comprised with the vehicle, the stream of data comprising a plurality of data elements, arranging the plurality of data elements in a plurality of different predetermined categories, forming a graphical representation of the data elements for each of the categories, wherein each data element is mapped to a predetermined color based on a value of the data element, receiving a graphical representation of the vehicle, identifying a location of at least one of the ECU, the sensor or communication means therebetween, and displaying the graphical representation of the vehicle and the graphical representation of the data elements within the GUI, the graphical representation of the data elements being overlaid at the location of the ECU, the sensor, or at the communication means therebetween. This aspect of the present disclosure provides similar advantages as discussed above in relation to the previous aspect of the present disclosure.

According to a further aspect of the present disclosure there is provided a computer program product comprising a non-transitory computer readable medium having stored thereon computer program means for operating a system adapted to analyze data in a vehicle, the system comprising a display screen provided with a graphical user interface (GUI), and processing circuitry arranged in communication with the display screen, wherein the computer program product comprises code for receiving a stream of data relating to an electronic control unit (ECU) or a sensor comprised with the vehicle, the stream of data comprising a plurality of data elements, code for arranging the plurality of data elements in a plurality of different predetermined categories, code for forming a graphical representation of the data elements for each of the categories, wherein each data element is mapped to a predetermined color based on a value of the data element, code for receiving a graphical representation of the vehicle, code for identifying a location of at least one of the ECU, the sensor or communication means therebetween, and code for displaying the graphical representation of the vehicle and the graphical representation of the data elements within the GUI, the graphical representation of the data elements being overlaid at the location of the ECU, the sensor, or at the communication means therebetween. Also this aspect of the present disclosure provides similar advantages as discussed above in relation to the previous aspects of the present disclosure.

The computer readable medium may be any type of memory device, including one of a removable nonvolatile random-access memory, a hard disk drive, a floppy disk, a CD-ROM, a DVD-ROM, a USB memory, an SD memory card, or a similar computer readable medium known in the art.

Further advantages and advantageous features of the present disclosure are disclosed in the following description and in the dependent claims.

### BRIEF DESCRIPTION OF THE DRAWINGS

With reference to the appended drawings, below follows a more detailed description of embodiments of the present disclosure cited as examples.

In the drawings:

FIG. 1A illustrates a truck, 1B a bus and 1C a wheel loader in which the control system according to the present disclosure may be incorporated;

FIG. 2 illustrates a conceptual system in accordance to a currently preferred embodiment of the present disclosure;

FIG. 3 presents a conceptual implementation of an augmented reality arrangement according to the present disclosure used in relation to the truck as shown in FIG. 1, and

FIG. 4 illustrates the processing steps for performing the method according to the present disclosure.

### DETAILED DESCRIPTION

The present disclosure will now be described more fully hereinafter with reference to the accompanying drawings, in which currently preferred embodiments of the present disclosure are shown. This disclosure may, however, be embodied in many different forms and should not be construed as limited to the embodiments set forth herein; rather, these embodiments are provided for thoroughness and completeness, and fully convey the scope of the disclosure to the skilled addressee. Like reference characters refer to like elements throughout.

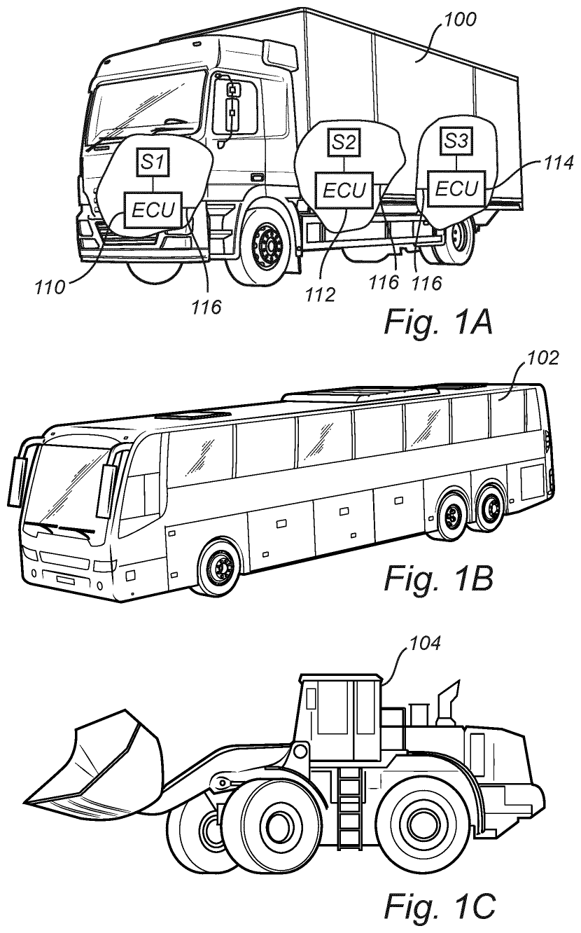

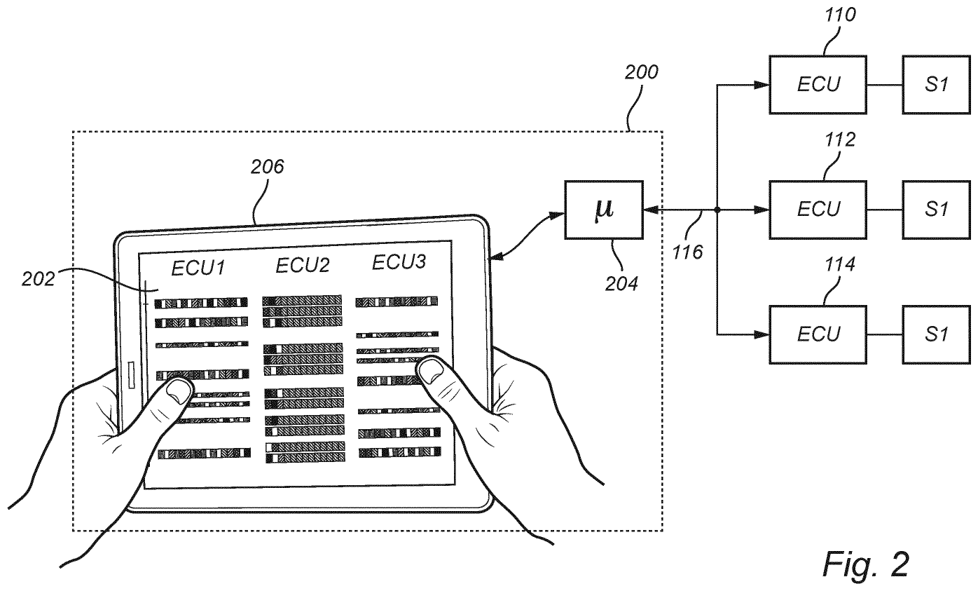

Referring now to the drawings and to FIG. 1A in particular, there is depicted an exemplary vehicle, here illustrated as a truck 100, in which a system 200 (as shown in FIG. 2) according to the present disclosure may be incorporated. The system 200 may of course be implemented, possibly in a slightly different way, in a bus 102 as shown in FIG. 1B, wheel loader 104 as shown in FIG. 1C, a car, a bus, etc.

The vehicle may for example be one of an electric or hybrid vehicle, or possibly a gas, gasoline or diesel vehicle. The vehicle comprises an electric machine (in case of being an electric or hybrid vehicle) or an engine (such as an internal combustion engine in case of being a gas, gasoline or diesel vehicle). The vehicle may further be manually operated, fully or semi-autonomous.

The vehicle, such as the truck 100, may typically comprise one or a plurality of ECU's, exemplified by three ECUs 110, 112 and 114 as conceptually illustrated in FIG. 1A. Each of the ECUs 110, 112, 114 may in turn be connected to sensors S1, S2, S3, respectively. The sensor S1, S2, S3 may for example be arranged to measure a temperature, a pressure, a speed, an acceleration, a flow, etc., in relation to components comprised with the vehicle. Such components may for example include a motor of the vehicle, for example but not limited to an internal combustion engine (ICE), an after-treatment arrangement, a pump, an actuator, etc. The ECUs 110, 112, 114 may also be internally connected using e.g. a CAN bus 116.

FIG. 2 shows a conceptual and exemplary implementation of the system 200 according to the present disclosure, wherein the system 200 is provided for allowing a user to analyze data in a vehicle, such as the truck 100.

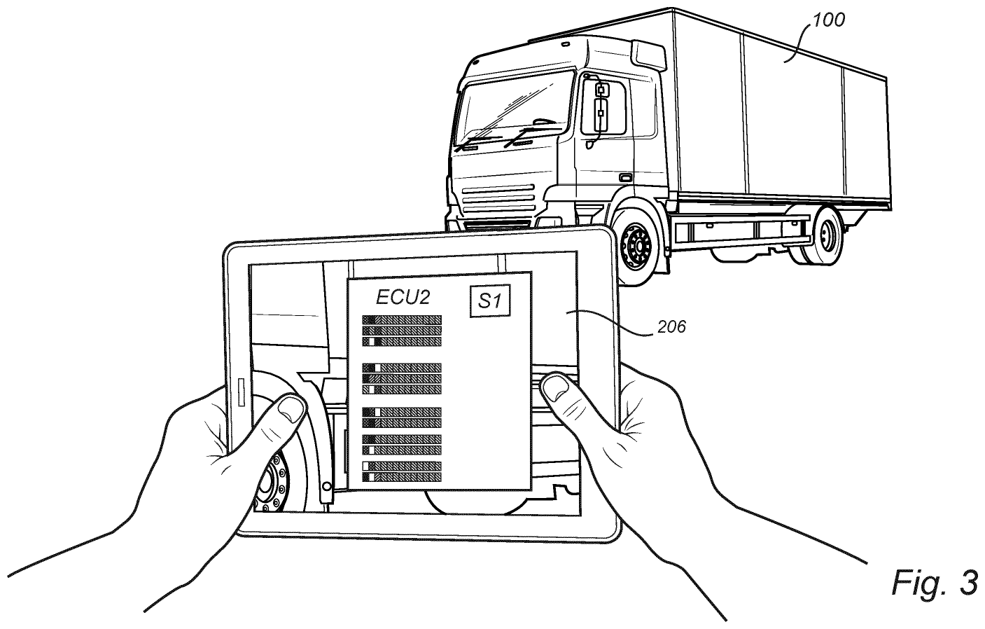

The system 200 comprises a display screen 202 adapted to present a graphical user interface (GUI) and a processing circuitry 204. The display screen 202 may for example be part of an electronic device such as a tablet 206. The display screen 202 may in another example be part of an augmented reality arrangement as will be further elaborated in FIG. 3.

For reference, the processing circuitry 202 may for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

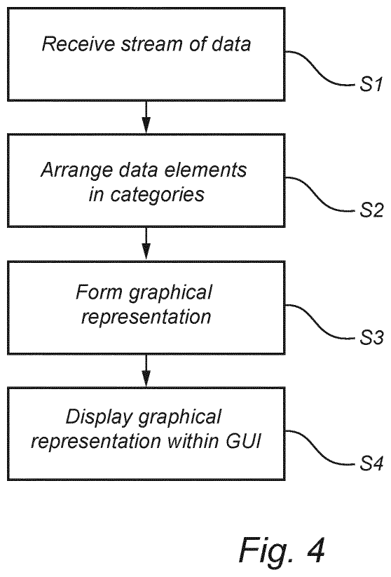

In line with the present disclosure and with further reference to FIG. 4, the processing circuitry 204 is arranged to receive, S1, a stream of data from e.g. one or a plurality of the ECUs 110, 112, 114 and/or one or plurality of the sensors S1, S2, S3 comprised with the vehicle, where the stream of data comprising a plurality of data elements. The data elements may in turn represent a value from/to e.g. one of the ECUs 110, 112, 114 and/or the sensors S1, S2, S3 and or the communication means therebetween, such as the CAN bus 116 (and/or similar present or future implementation of the communication means, including any form of IP based communication), being an intermediate indication of a measurement (such as from the sensors S1, S2, S3) or an outcome of a processing performed by the ECUs 110, 112, 114. The stream of data may also be received at one or a plurality of the ECUs 110, 112 and 114 using the CAN bus 116.

Once the stream of data has been received at the processing circuitry 204, the processing circuitry 204 will arrange, S2, the plurality of data elements comprised with the stream of data in a plurality of different predetermined categories. An example of a category may be data elements from a specific sensor or ECU, where e.g. all data from a specific sensor or ECU is arranged together. Another type of category may be data elements relating to a specific function, such as a function performed by one or a plurality of the ECUs 110, 112 and 114. Such a function could for example be a transmission or reception of data to/from one or a plurality of the ECUs 110, 112 and 114.

Based on the categorization, the processing circuitry will subsequently form, S3, a graphical representation for each of the categories, wherein each data element is mapped to a predetermined color based on a value of the data element. As an example, the data elements generated by one or a plurality of the ECUs 110, 112 and 114, or one or a plurality of the sensors S1, S2, S3, may be seen as having a “value”, such as a hexadecimal value defining one of 16 different values.

The color mapping may in such an embodiment be seen as the mapping of a data element having one of 16 different values (e.g. 0, 1, 2, 3, 4, 5, 6, 7, 8, 9, A, B, C, D, E, F). A corresponding number of different colors are then selected to be mapped to the 16 different values. As an example, 0 may be mapped to black, 1 may be mapped to white, etc.).

In a preferred embodiment of the present disclosure it is desirable to select colors that are easily visually separable from each other, improving how the user may distinct the different values from each other.

Furthermore, it is desirable that the graphical representation is formed in such a manner that more than a single data element is included, e.g. from each of the ECUs 110, 112,114 and/or the plurality of sensors S1, S2, S3. Accordingly, it is thus preferred that a plurality of subsequent data elements from one category are included in the graphical representation, providing the user with a possibility to review how the values of the data elements are developing over time. In a possible embodiment it may for example be possible to allow 10-100 data elements (or less or more) from a single category to be “stacked” after each other in the graphical representation. Thus, a possible fluctuation over time may be easily identified by the user. In some embodiments the data elements are updated every 1-100 milliseconds (ms), preferably every 10 ms.

Once the graphical representation has been prepared it is displayed, S4, within the GUI of the display screen 202.

In FIG. 3 there is shown a possible implementation of the present disclosure, where the tablet 206 has been adapted as forming part of an augmented reality arrangement. It may of course, and within the scope of the present disclosure, use other electronic means for achieving a similar function (i.e. instead of the tablet 206), instead using one of smart eyeglasses, a smartphone, etc.

As exemplified in FIG. 3, the tablet 206 is provided with a camera (not shown), where the camera is arranged to capture a “live stream” of the truck 100 that is placed in the background.

In line with the present disclosure, the video stream of the video is analyzed by the processing circuitry 204, to e.g. identify distinct features of the truck 100. Once the position of the identifiable features has been located, it may in line with the present disclosure be possible to augment the video sequence with further information. As exemplified in FIG. 3, information relating to components of the truck 100 may be “overlaid” onto the visualization of the truck 100 within the GUI of the tablet 206. In FIG. 3 such components may for example comprise the ECUs 110, 112, 114, the sensors S1, S2, S3 and/or the CAN bus 116 as discussed above, as well as thereto related elements of the truck that are not otherwise visibly seen by a user, since they are components that are “embedded” within the truck. That is, they are typically not visible if not taking apart the truck 100. It may of course be possible to not show an exact visualization of the different components, but rather a representation of said components.

Furthermore, and as shown in FIG. 3, it may in line with the present disclosure be possible to also include the graphical representation of the stream of data from the ECUs 110, 112, 114. Accordingly, in line with the present disclosure the GUI of the tablet 206 may be arranged to at the same time show the video stream of the truck 100, a representation of the component of the truck 100 (such as exemplified with ECU 112) at an estimated location of the component and/or the CAN bus 116, as well as the graphical representation, where the graphical representation in such a view is selected to only comprise information relating to the ECU that is currently comprised within the GUI of the tablet 206.

It should be understood that the visualization and mapping of the ECUs 110, 112,114 and/or the plurality of sensors S1, S2, S3 and/or the communication means (e.g. the CAN bus 116) must not necessarily be the an exact, but rather estimated in an actual location, position and/or extension at the vehicle 100, 102, 104. For example, the CAN bus 116 may in some visualizations be shows as a “straight line” between e.g. the ECUs 110, 112,114 and/or the plurality of sensors S1, S2, S3.

Further information may of course additionally be included within the GUI, such as schematics for the relevant component(s) of the truck 100, suggestions of actions based on a content of the data stream, representative fault codes, etc.

In summary, the present disclosure relates to a system for analyzing data in a vehicle, such as an ECU comprised with the vehicle. The present disclosure also relates to a corresponding computer implemented method and to a computer program product.

The advantage with such a system is that a skilled technician quickly may draw a conclusion from observing graphical representation formed in line with the present disclosure, since a skilled technician in many situations may remember how a flow of data from a specific sensor or ECU should likely appear in case of the sensor/ECU is “working properly”. Distinct differences in what would be a normal behavior may thus be easily identified and an action may be taken. As an example, in case a sensor/ECU normally producing e.g. blue data is shown to display e.g. another color, such as red, may be taken as an indication that something is erroneous in relation to the sensor/ECU.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Additionally, even though the disclosure has been described with reference to specific exemplifying embodiments thereof, many different alterations, modifications and the like will become apparent for those skilled in the art.

Variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. A system for analyzing data in a vehicle, the system comprising:
a display screen provided with a graphical user interface (GUI), and
processing circuitry arranged in communication with the display screen, the processing circuitry is configured to:
receive a stream of data relating to an electronic control unit (ECU) or a sensor of the vehicle, the stream of data comprising a plurality of data elements,
arrange the plurality of data elements in a plurality of different predetermined categories,
form a graphical representation of the data elements for each of the categories, each data element mapped to a predetermined color based on a value of the data element,
receive a graphical representation of the vehicle,
identify a location of at least one of the ECU, the sensor, or a communication device therebetween, and
display the graphical representation of the vehicle and the graphical representation of the data elements within the GUI, the graphical representation of the data elements being overlaid at the location of the ECU, the sensor, or at the communication device therebetween.

2. The system of claim 1, wherein the data elements are time stamped and the processing circuitry is further configured to:
order the data elements in each category based on the time stamp prior to forming the graphical representation.

3. The system of claim 1, wherein the data comprises fault codes for the vehicle.

4. The system of claim 1, wherein the stream of data is CAN bus data.

5. The system of claim 1, wherein the communication device between the ECU and the sensor is a wired or wireless CAN bus.

6. The system of claim 1, wherein the plurality of data elements are hexadecimal values.

7. The system of claim 1, wherein the display screen forms part of an augmented reality arrangement, the augmented reality arrangement represented by at least one of smart eyeglasses, a smartphone, and a tablet.

8. A vehicle comprising the system (200) according to claim 1.

9. The vehicle of claim 8, wherein the vehicle is a truck, a bus, or a working machine.

10. A computer implemented method for operating a system adapted to analyze data in a vehicle, comprising:
receiving a stream of data relating to an electronic control unit (ECU) or a sensor comprised with the vehicle, the stream of data comprising a plurality of data elements,
arranging the plurality of data elements in a plurality of different predetermined categories,
forming a graphical representation of the data elements for each of the categories, wherein each data element is mapped to a predetermined color based on a value of the data element,
receiving a graphical representation of the vehicle,
identifying a location of at least one of the ECU, the sensor, or a communication device therebetween, and
displaying the graphical representation of the vehicle and the graphical representation of the data elements within a graphical user interface (GUI) of a display screen, the graphical representation of the data elements being overlaid at the location of the ECU, the sensor, or at the communication device therebetween.

11. The method of claim 10, wherein the data elements are time stamped and the method further comprises:
ordering, by the processing circuitry, the data elements in each category based on the time stamp prior to forming the graphical representation.

12. The method of claim 10, wherein the data comprises fault codes for the vehicle.

13. The method of claim 10, wherein the stream of data is CAN bus data.

14. The method of claim 10, wherein the plurality of data elements are hexadecimal values.

15. A computer program product comprising a non-transitory computer readable medium having stored thereon computer program for operating a system adapted to analyze data in a vehicle, the system comprising:
a display screen provided with a graphical user interface (GUI), and
processing circuitry arranged in communication with the display screen,
the computer program product, when executed, configured to:
receive a stream of data relating to an electronic control unit (ECU) or a sensor comprised with the vehicle, the stream of data comprising a plurality of data elements,
arrange the plurality of data elements in a plurality of different predetermined categories,
form a graphical representation of the data elements for each of the categories, wherein each data element is mapped to a predetermined color based on a value of the data element,
receive a graphical representation of the vehicle,
identify a location of at least one of the ECU, the sensor, or a communication device therebetween, and
display the graphical representation of the vehicle and the graphical representation of the data elements within a graphical user interface (GUI) of a display screen, the graphical representation of the data elements being overlaid at the location of the ECU, the sensor, or at the communication device therebetween.
